(19) United States
(12) Patent Application Publication
(10) Pub. No.: US 2017/0032478 A1
(43) Pub. Date: Feb. 2, 2017

(54) System, Method, and Apparatus for Ordering and Paying

(71) Applicant: CARLTON COURT HOLDINGS, LLC, WINTER HAVEN, FL (US)

(72) Inventors: Todd A. Kraft, Winter Haven, FL (US); Ryan T. Kraft, Winter Haven, FL (US); John M. Kraft, Winter Haven, FL (US); Kyle B. Kraft, Winter Haven, FL (US)

(73) Assignee: CARLTON COURT HOLDINGS, LLC, WINTER HAVEN, FL (US)

(21) Appl. No.: 14/814,950

(22) Filed: Jul. 31, 2015

(51) Int. Cl. G06Q 50/12; G06Q 20/20; G06Q 20/32; G06Q 30/06

(52) U.S. Cl. CPC G06Q 50/12; G06Q 30/0635; G06Q 20/202; G06Q 20/32

(57) ABSTRACT

A system, method, and apparatus for ordering items includes an application for a portable device that presents an establishment selection user interface. The application receives a selection of an establishment and then retrieves a menu associated with the establishment from a server which the application displays. The application receives item selections from an input device of the portable device then sends the item selections to the server. The server displays the selections at a terminal associated with the establishment. After fulfilling the items, a completion transaction is sent from the terminal associated with the establishment to the server, and, responsive to such, the server sends a transaction to the application indicating the items are fulfilled. The application displays a message indicating that the item selections are ready on the display of the portable device.

### FIELD

This invention relates to the field of ordering and more particularly to a system for ordering drinks and/or food at various establishment.

### BACKGROUND

There are many times when it is difficult to impossible to place an order, especially at a busy establishment such as a bar, tap room, restaurant bar, coffee shop, etc. Some establishments have a fixed queue for placing orders, for example, several coffee shops in airports have such to reduce chaos and increase fairness to all patrons.

Typically, in establishments with bars, there is seating around the bars for patrons to sit and enjoy a drink and/or food. As such establishments become more crowded, many people congregate around the bar, filling most available spaces and making it difficult for other customers to reach the bar and get the attention of the bartender. In such, it is entirely possible that the bartender(s) stand idle while customers at the periphery go thirsty or hungry.

Recently, some restaurants have implemented seat-based ordering systems for patrons to directly place orders on tablet computers that are provided at the tables. After placing the orders, the food and/or drink are delivered directly to the tables. Such systems are proprietary and rely on pre-programmed devices such as tablet computers provided by the establishments.

In a busy environment, it is often extremely challenging for the bartenders to manage the patron queue that builds, fulfilling orders in a fair and equitable fashion. A comprehensive system is needed to increase the information exchange between the patron and establishment including, but not limited to, establishment wait times, varying stages of order processing (outside of just completion), contact information, specials menu items, and prices

What is needed is a system that will provide for ordering of drink and/or food using the customer's personal device (e.g., the customer's cell phone).

### SUMMARY

In one embodiment, a system for ordering items from a portable device is disclosed including a server with a portable device communicatively connected to the server through a network. A point-of-sale system associated with an establishment(s) is also communicatively connected to the server through the network as well as an ordering terminal associated with the establishment. A menu is retrieved from the point-of-sale system by the server. An application running on the portable device presents a user interface for selecting the establishment and upon the application receiving a selection of the establishment, the application presents a menu interface including items from the menu and including ordering options. The application accepts an order and sends the order to the server. Upon receipt of the order from the portable device, the server presents details of the order at the ordering terminal associated with the establishment. After fulfillment of the order, a completion transaction is conveyed from the ordering terminal to the server and upon receipt of the completion transaction, the server sends a completion transaction to the portable device indicating that the order is ready.

In another embodiment, a method of ordering items at an establishment is disclosed including running an application on a portable device, the application presenting an establishment selection user interface. The application receives a selection of an establishment and then retrieves a menu associated with the establishment from a server which the application presents on a display of the portable device. The application receives one or more item selections from an input device of the portable device then the application sends the one or more item selections to the server (e.g., in a transaction). The server displays the item selections at a terminal associated with the establishment (e.g., for preparation by a personnel of the establishment). After fulfilling the items, a completion transaction is sent from the terminal associated with the establishment to the server, and, responsive to such, the server sends a transaction to the application indicating the items are fulfilled. The application displays a message indicating that the item selections are ready on the display of the portable device.

In another embodiment, an apparatus for ordering items is disclosed including a portable device having a processor, display, memory, an input device, and communications interface. An application is stored in the memory of the portable device and runs on the processor. The application presents a user interface on the display of the portable device representing a selection of establishments and then receives a selection of one establishment from the input device of the portable device (e.g. from a touch screen). Next, the application retrieves a menu from a server and displays the menu on the display. The menu is of items associated with the selected establishment. Next, the application receives selections of one or more items of the menu from the input device. When finished entering the selections, the application sends a list of the selected items to the server and the server presents the list of the one or more items to a terminal associated with the selected establishment for a person at that establishment to prepare/deliver. When finished, the one or more items are delivered.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a bar of the prior are.

FIG. 2 illustrates a plan view of an exemplary bar implementing a beverage ordering system.

FIG. 3 illustrates a data connection diagram of the exemplary beverage ordering system.

FIG. 4 illustrates a schematic view of a typical cell phone system as used in the beverage ordering system.

FIG. 5 illustrates a schematic view of a first user interface of the beverage ordering system.

FIG. 6 illustrates a schematic view of a second user interface of the beverage ordering system.

FIG. 7 illustrates a schematic view of the second user interface of the beverage ordering system with order information.

FIG. 8 illustrates a schematic view of a third user interface of the beverage ordering system.

FIG. 9 illustrates a schematic view of a fourth user interface of the beverage ordering system.

FIG. 10 illustrates a schematic view of a fifth user interface of the beverage ordering system.

FIG. 11 illustrates a schematic view of a sixth user interface of the beverage ordering system.

FIG. 12 illustrates a schematic view of a seventh user interface of the beverage ordering system.

FIG. 13 illustrates a schematic view of an eighth user interface of the beverage ordering system.

FIG. 14 illustrates a schematic view of a first bar-located user interface of the beverage ordering system.

FIG. 15 illustrates a schematic view of a second bar-located user interface of the beverage ordering system.

FIG. 16 illustrates a schematic view of a third bar-located user interface of the beverage ordering system.

FIG. 17 illustrates an exemplary flow chart of the beverage ordering system.

FIG. 18 illustrates a second exemplary flow chart of the beverage ordering system.

FIG. 19 illustrates a third exemplary flow chart of the beverage ordering system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

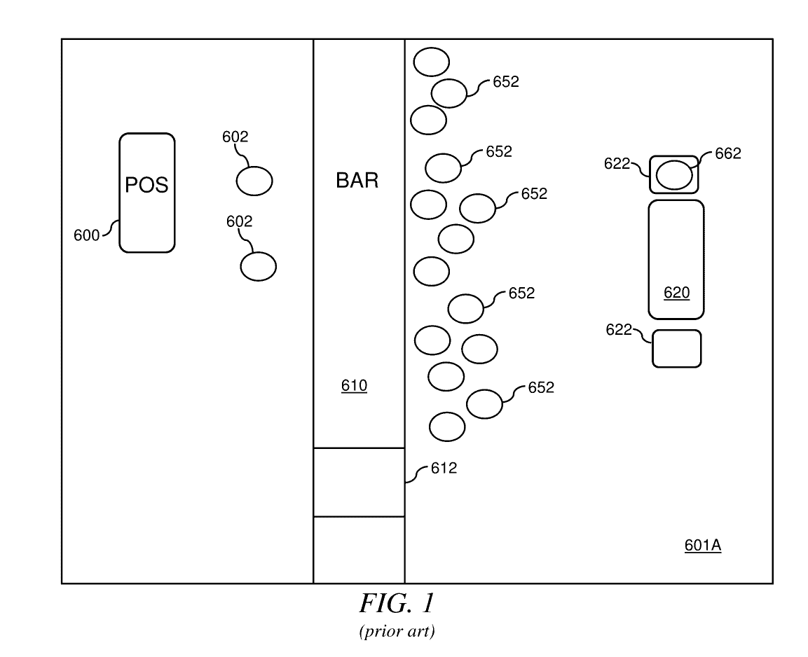

FIG. 1 illustrates a schematic view of an establishment 601A (in this example, a bar) of the prior are. The examples provided are generally for a bar for illustrative purposes, though the ordering system described is anticipated to be used and adapted to any similar or different establishment such as a restaurant, coffee shop, bakery, deli, noodle shop, fast food, etc.

The exemplary establishment 601A of the prior art typically has one or more bartenders 602 and a point-of-sale system 600 for entering drink orders by the bartenders 602. Typically, the bartender(s) 602 are typically separated from the customers 652 by a physical bar 610 (e.g., an elongated table, etc.), often with an access door 612 that hinges upwardly to allow exit by the bartender(s) 602. In this example, the bar area is crowded with many customers 652. A patron 662 is sitting in a chair 622 at a table 620 distal from the physical bar 610 and would like another drink. Now, even though the bartender(s) 602 are possibly idle, the patron 662 finds it difficult to approach the physical bar 610 and even more difficult for the patron 662 to place an order. Such situations are even further hampered if the patron 662 is introverted, making it difficult for the patron 662 to assert his/herself and make his/her way through the crowd of customers 652.

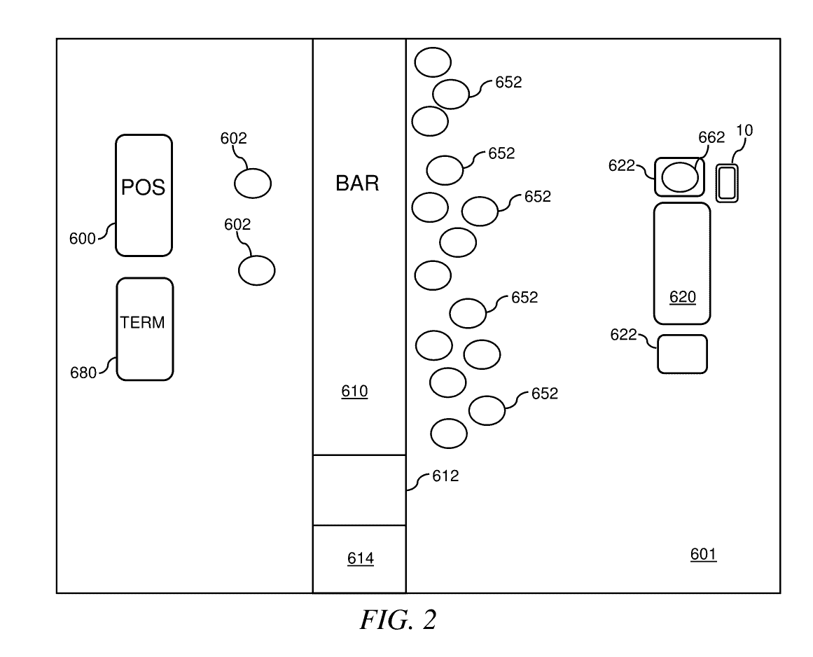

FIG. 2 illustrates a plan view of the establishment 601 (similar to that described above), implementing a item ordering system. Again, the examples provided are generally for a bar for illustrative purposes as the item ordering system described is anticipated to be used and adapted to any similar or different establishment such as a restaurant, coffee shop, bakery, deli, noodle shop, fast food, etc.

As in the above, the exemplary bar of 601 typically has one or more bartenders 602 and a point-of-sale system 600 for entering drink orders by the bartenders 602. In this, there is also an ordering terminal 680, such as a dedicated tablet computer, etc., preferably in view of the bartender(s) 602. Again, typically, the bartender(s) 602 are separated from the customers 652 by a physical bar 610 (e.g., an elongated table, etc.), often with an access door 612 that hinges upwardly to allow exit by the bartender(s) 602. In this example, the bar area is crowded with many customers 652. A patron 662 is sitting in a chair 622 at a table 620 distal from the physical bar 610 and would like another drink.

Using the disclosed item ordering system, the patron 662 does not need to get the attention of the bartender(s) 602 to place an order. Instead, the patron 662 opens the order application on their cell phone 10 and places their order, as will be described. The bartender(s) 602 receive the order on a ordering terminal 680, typically in the vicinity of the point-of-sale system 600. After seeing the order from the patron 662, the bartender(s) 602 concoct/pour the desired drinks and deliver the drinks to the other patron 662 by, for example, placing the drinks at a pre-determined pickup location 614 or delivering the drinks to the patron's table 620.

Note that the examples shown include a cell phone 10 for clarity reasons as any type, style, and/or size of portable device is anticipated, including cell phones 10, tablet computers, portable computers, etc.

In this system, there are benefits to both the patron 662 and to the establishment 601. As described, the process of ordering a drink is greatly simplified for the patron 662, eliminating the need to approach the bar and garner the bartender(s) 602 attention. From the perspective of the establishment 601 (and the bartenders 602), the process of fulfilling orders is simplified, eliminating many of the payment transactions (as will be described) and, certainly, eliminating the order capture process which is often difficult in a noisy establishment 601, often leading to errors, unhappy bartender(s) 602, and/or an unhappy patrons 662.

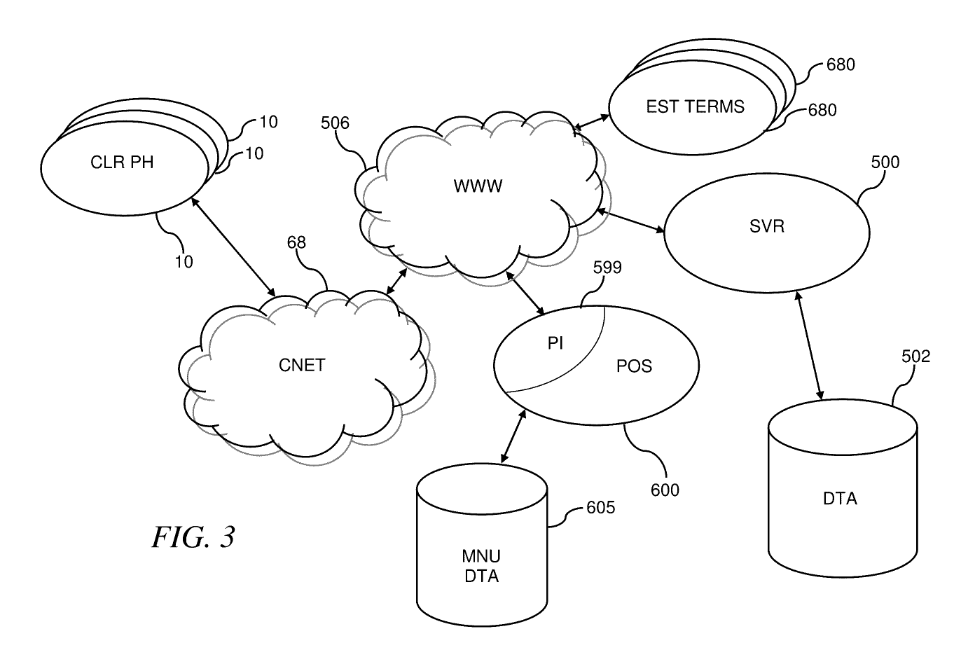

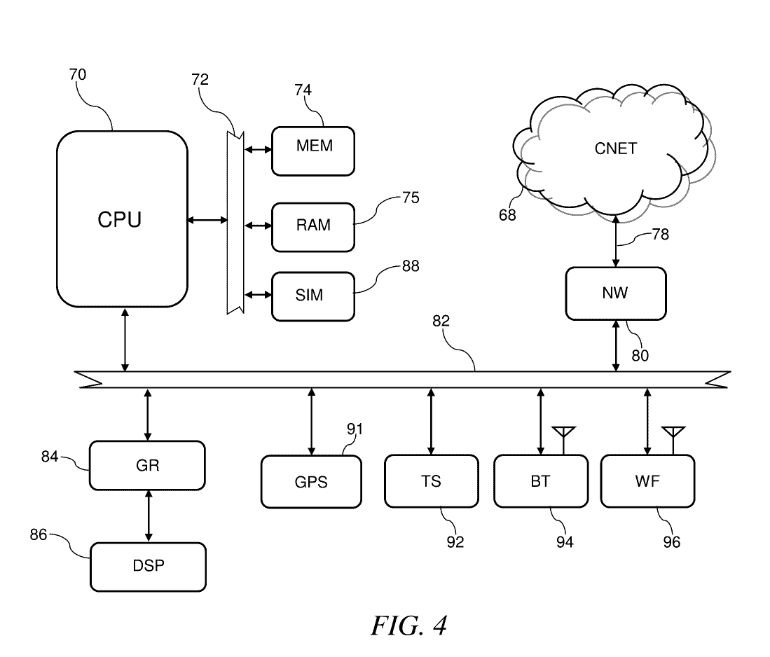

FIG. 3 illustrates a data connection diagram of the exemplary item ordering system. In this example, one or more cell phones 10 communicate through the cellular network 68 and/or through a wide area network 506 (e.g. the Internet) to a server computer 500. The server computer 500 has access to data storage 502. Although one path to/from the cell phones 10 through the cellular network 68 is through the wide area network 506 and to/from the server computer 500 as shown, any known data path is anticipated. For example, the Wi-Fi transceivers 96 (see FIG. 4) of a cell phone 10 is used to communicate directly with the wide area network 506, which includes the Internet, and, consequently, with the server computer 500.

The server computer 500 transacts with the cell phones 10 through the network(s) 68/506 to register the cell phones 10, to present menus to/on the cell phones 10, to accept orders from the cell phones 10, and to effect payment for drinks/food/items that were ordered (note, that it is fully anticipated that non-consumable items are also orderable, for example, coffee mugs, t-shirts, etc.). In this, in some embodiments, payment credentials (e.g., credit card number, expirations, secret codes) are stored local to the cell phone 10; while in other embodiments, payment credentials (e.g., credit card number, expirations, secret codes) are stored in a data storage 502 (preferably in a secured area). In some embodiments, no payment credentials are stored and the user of the cell phone 10 (the patron 662) enters payment credentials at the time of ordering, runs a tab, or pays in cash when receiving the ordered products. When running a tab, the patron 662 has the option to enter credit card information at the time of payment/settlement and/or has the option to pay with cash or check. Further, there is no limitation regarding the form of payment as all known and future payment facilities are anticipated such as electronic currencies, payment services, etc.

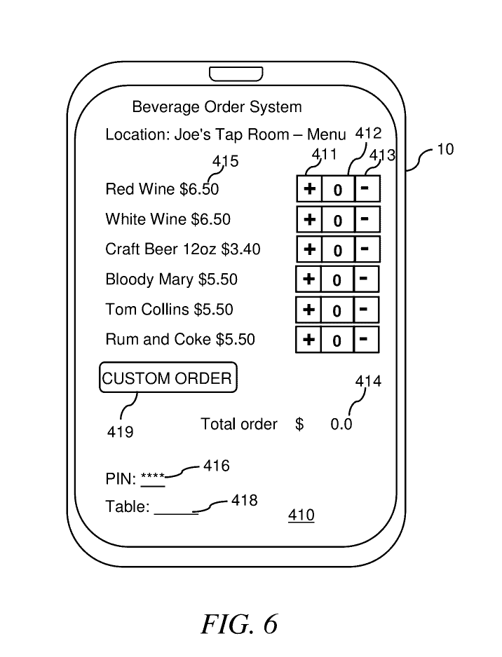

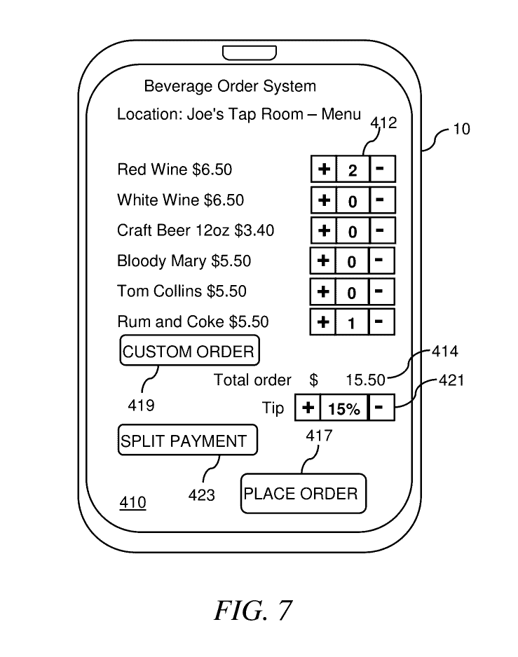

In order to obtain menu lists, stocking levels, and capabilities of the establishment and to arrange payment to the establishment from the patron 662, a link is established between the point-of-sale system 600 of the establishment and the server computer 500, typically through the wide-area network 506, though not limited to any particular connection path. In order to provide access of the point-of-sale system 600 to the server computer 500, it is anticipated that point-of-sale interface software 599 is installed on the point-of-sale system 600, often called a plug-in, permitting the server computer 500 to transact with the point-of-sale system 600 to obtain menu data and stocking information, and to provide payment compensation. The menu information and stocking information is used to present menu/order user interface 410 (e.g., as shown in FIGS. 6 and 7). In this, the stocking information is used to suppress menu items that are out-of-stock, for example, if the establishment 602 is out of rum, then no menu item is displayed that includes rum (e.g., Rum and Coke is removed from the menu).

The point-of-sale system 600 has local storage 605 for storing transaction records, menus, etc. There are many known or future point-of-sale systems, for example, Micros, Aloha, Positouch, etc. It is anticipated that in some embodiments, each menu item includes an item ID (identification) to index each item to one or more menu pages and for customized menu pages, etc. In some embodiments, the menu items include images of the item, nutritional information of the item, alcohol content, size of the drink/food, liquor brand, etc.

Further, in some embodiments, the menu/order user interface 410 (see FIGS. 6 and 7) is configured by certain parameters such as number of customers 552 in the establishment 602, time of day, popularity of certain items, special events, holidays, etc. For example, if happy hour is from 5:00 PM to 7:00 PM, the prices of certain drinks are modified during that time period, perhaps halved. Additionally, it is anticipated that when the modifications are made, fonts and/or colors are optionally used to highlight the changes (e.g. happy hour selections are presented in a different color font).

Further, in some embodiments, the menu/order user interface 410 provides a “re-order” function that, when activated, places a new order for the identical items that were last ordered.

Referring to FIG. 4, a schematic view of a typical cell phone 10 is shown. The example cell phone 10 represents a typical phone system used for order entry. This exemplary cell phone 10 is shown in its simplest form. Different architectures are known that accomplish similar results in a similar fashion and the present invention is not limited in any way to any particular cell phone 10 system architecture or implementation. In this exemplary cell phone 10, a processor 70 executes or runs programs in a random access memory 75. The programs are generally stored within a persistent memory 74 and loaded into the random access memory 75 when needed. Also accessible by the processor 70 is a SIM (subscriber information module) card 88 having a subscriber identification and often persistent storage. The processor 70 is any processor, typically a processor designed for phones. The persistent memory 74, random access memory 75, and SIM card are connected to the processor by, for example, a memory bus 72. The random access memory 75 is any memory suitable for connection and operation with the selected processor 70, such as SRAM, DRAM, SDRAM, RDRAM, DDR, DDR-2, etc. The persistent memory 74 is any type, configuration, capacity of memory suitable for persistently storing data, for example, flash memory, read only memory, battery-backed memory, magnetic memory, etc. In some exemplary cell phones 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on a display image on the display 86. The touch screen interface 92 provides navigation and selection features.

In general, some portion of the persistent memory 74 and/or the SIM card 88 is used to store programs, executable code, phone numbers, contacts, and data such as stored payment credentials, etc. In some embodiments, other data is stored in the persistent memory 74 such as audio files, video files, text messages, etc.

The peripherals are examples and other devices are known in the industry such as Global Positioning Subsystem 91, speakers, microphones, USB interfaces, Bluetooth transceivers 94, Wi-Fi transceivers 96, image sensors, temperature sensors, etc., the details of which are not shown for brevity and clarity reasons.

The cellular network interface 80 connects the cell phone 10 to the cellular network 68 through any cellular band and cellular protocol such as GSM, TDMA, LTE, etc., through a wireless medium 78. There is no limitation on the type of cellular connection used. The cellular network interface 80 provides voice call, data, and messaging services to the cell phone 10 through the cellular network.

For local communications, many cell phones 10 include a Bluetooth transceiver 94, a Wi-Fi transceiver 96, or both. Such features of cell phones 10 provide data communications between the cell phones 10 and data access points and/or other computers such as a personal computer (not shown).

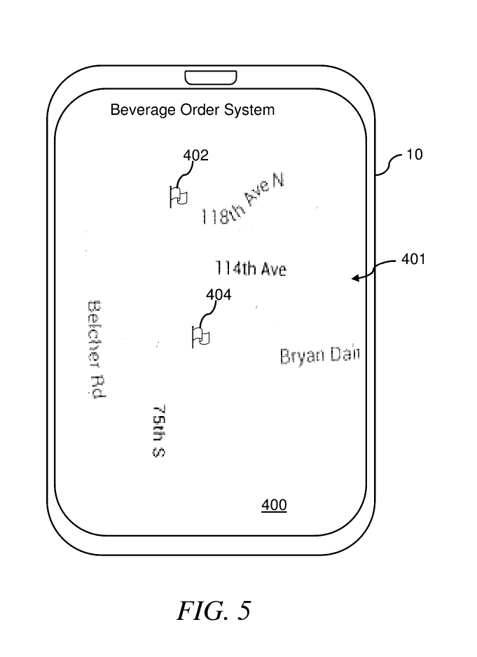

Referring to FIGS. 5-13, several exemplary schematic views of a user interface of the beverage ordering system are shown. The user interfaces shown are for illustrative purposes and it is fully anticipated that other user interfaces with similar or different designs will accomplish the same or similar tasks in similar or different ways, all of which are included in the present application. For example, in some embodiments, voice recognition is used by the patron 662 to order items or scannable codes on a printed menu are scanned/recognized by the cell phone 10, etc.

In FIG. 5, a map user interface 400 is shown. In such, software operating on the cell phone 10 as part of the user interface application has determined the location of the cell phone 10 using the Global Positioning Subsystem 91 of the cell phone 10. The application then accesses a map 401 of a certain geographic area within the local of the cell phone 10 (and therefore the area in which the patron 662 is located). The application reports the location of the cell phone 10 to the server computer 500 and the server retrieves locations of nearby establishments 601 (two establishments 601 are shown indicated by flags 402/404, while any number of establishments is/are anticipated), forwarding the locations of the establishments 601 to the application. The application presents the locations of the establishments 601 on the map 401 that is then displayed on the display 86 of the cell phone 10. In this example, the locations of the establishments 601 are presented as flags 402/404 or push-pins on a map 401, though any form of user interface is anticipated.

In some embodiments, the application establishes a connection to the server computer 500 and retrieves information about the establishments 601 such as load factors, estimated number of customers 652 present, estimated wait time, closing time, etc. In such embodiments, the information about the establishments 601 is displayed, for example, when the patron 662 selects the establishment 601, for example, by hovering over the flag 402/404 associated with the establishment 601.

The significance of this type of map user interface 400 is twofold. It provides advertisement for establishments 601 that have joined a network of establishments utilizing the described system; and it provides the patron 662 (e.g., holder of the cell phone 10) with choices of establishments 601 that the patron 662 knows operates within the described system and, hence, provides ease of ordering of drinks, food, etc. In embodiments in which information is retrieved and displayed regarding the establishment 601, the patron 662 is provided further information to help in selection. For example, if the establishment 601 is at capacity or maybe empty, the patron 662 has knowledge to select another establishment 601.

In this first user interface, the patron 662 has the ability to select either of the establishments 601, for example, by touching the respective flags using the touch screen interface 92. Once one of the flags is touched, a menu and establishment name is displayed as in the menu/order user interface 410 shown in FIGS. 6 and 7. Alternately, other user interface screens are anticipated before or after the menu/order user interface 410 such as an advertisement user interface (not shown) advertising certain products available at the establishment 601 or a specials user interface (not shown) advertising specials, for example, reduced prices at happy hour, etc.

A menu/order user interface 410 is shown in FIGS. 6 and 7. For simplicity reasons, a single-page menu is shown, though any number of pages is anticipated. Likewise, a drink menu is shown, though any type of product is anticipated including food, novelty products, clothing, glass ware, etc.

One of the major barriers to ordering using applications running on cell phones 10 is the limited real estate available on the display 86 of the cell phone 10. Therefore, it is anticipated that the user interface used for selection/ordering is designed to maximize information displayed while minimizing number of clicks for the patron 662. Although, for clarity reasons, the user interfaces shown are greatly simplified, it is fully anticipated that a more hierarchical user interface is presented, for example, providing drop-down interfaces for classes of products (e.g., beer, wine, cocktails, etc.). Further, menu items that require customization are anticipated to include selection paradigms such as selection wheels, scroll bars, pull down tabs, etc., to manage the large variety of customizable ingredients. For example, consider a martini having a scroll wheel for alcohol type (e.g., vodka, gin), size (e.g., large, small), alcohol amount (e.g., single shot, double shot), garnish (e.g., olive, lime), etc.

By using the described application and capabilities over time, history is maintained by the system (e.g., history records are stored in the memory 74 of the cell phone 10 and/or in the data storage 502 by the server 500). Having this historical data enables tunable menus that are adjusted by patron 662 and/or other parameters such as time-of-day, day-of-week, season, month, holidays, etc. For example, if a patron 662 always orders red wine, then the menu for each establishment 601 is configured to move red wine to the initial screens. If a patron 662 usually drinks beer on Sundays during football season, but drinks mixed drinks on other nights, then the menu is configured with beer selections first on Sundays during football season, and the menu is configured with mixed drink selections first on all other days.

Having historical data and dynamic data such as the seating capacity of an establishment 601, the estimated number of patrons in the establishment 601 by hour, the current frequency of drink fulfillment, the estimated number of customers 652 in the establishment 601, etc., the described system, in some embodiments, has features to adjust prices accordingly. For example as the number of customers 652 increase over certain thresholds, the prices on certain drinks (e.g., drinks that are difficult and time consuming to produce) or all drinks increase. In another example, if fewer patrons 662 utilize the system, then prices for patrons 662 using the system are decreased accordingly. Further, in some examples, inventory is used to adjust prices such as if the establishment is over stocked with rum, then prices are reduced for rum drinks, etc. In another example, an establishment 601 gives lower prices for a special event such as an anniversary of the day the establishment 601 opened, etc.

In the menu/order user interface 410, there are order counts 412 surrounded by increase/decrease buttons, though any method of data entry is anticipated. In this example, by pressing the increase icon 411, the number of the corresponding order count 412 is increased and by pressing the decrease icon 413, the number of the corresponding order count 412 is decreased, typically not going below zero. In the menu/order user interface 410, if the patron 662 wants to order two glasses of red wine, the patron 662 touches the screen over the increase icon 411 (′+′) that corresponds to red wine twice and the order count 412 for the red wine increase to two. Also, a cost 415 for each item is also associated with each item showing the patron 662 how much each item will cost when ordered. The total order cost 414 (sum) is displayed.

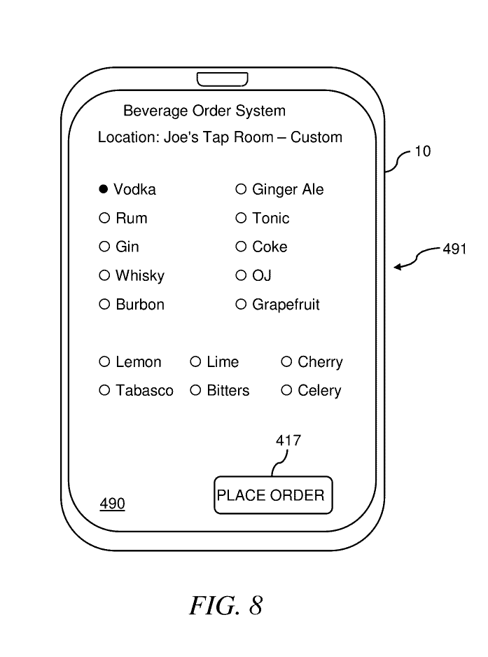

In some embodiments, if the patron 662 does not see a particular item that is desired, the patron 662 has a feature for a custom order 419. Touching the screen at the location of custom order 419 will result in a custom order user interface 490 as shown in FIG. 8.

In some embodiments, each patron 662 has a pin 416 for added security, being that in some embodiments, credit card or other payment credentials are saved/retained for quick ordering. In such embodiments, before ordering drinks, the patron 662 must enter the correct pin 416. The pin 416 is one known security mechanism and any known security mechanism is fully anticipated, including biometric security (facial scans, finger prints, voice prints, etc.), including retry counts, disabling access after a number of retries, etc.

In some embodiments, when the establishment 601 has tables 620, it is anticipated that the tables will be identified, for example, by table placards or numbers printed on the tables 620. In such, if the patron 662 wishes for the orders to be delivered to the table 620, the patron 662 enters the table number 418 in the menu/order user interface 410 (e.g. through text entry).

It is fully anticipated that other information be presented on the menu/order user interface 410 such as estimated wait time, names of the bartenders 602, trends. For example, if the most ordered drink in the last 24 hours in the establishment 601 was a cosmopolitan, then a box with an image of the drink is displayed in the menu/order user interface 410 informing the patron 662 that this is a very popular drink, lately, and, therefore, it is likely that the drink is good since other customers 652 are ordering such.

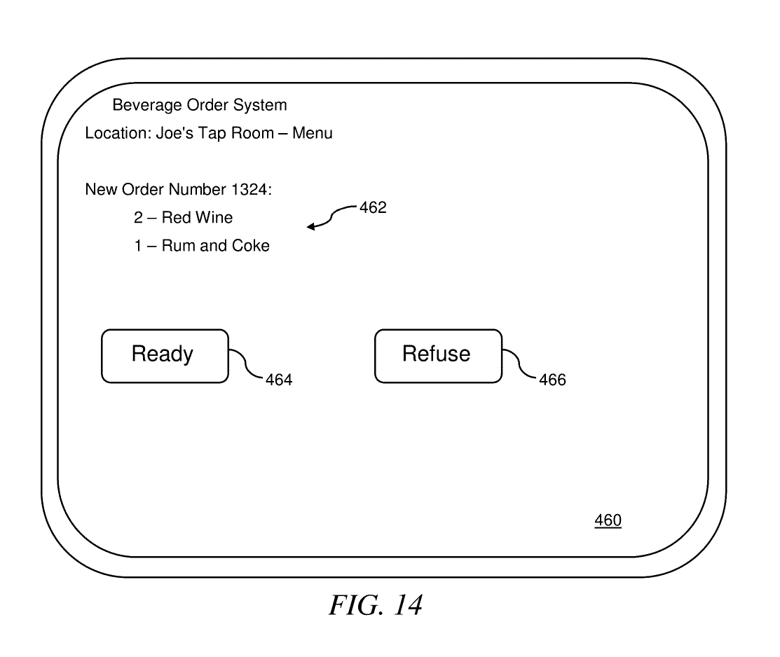

In FIG. 7, menu/order user interface 410 is shown after the patron 662 has created an order (entered data). For simplicity, the pin 416 and table number 418 is not shown in this example. In this example, the patron 662 has ordered two glasses of red wine and one rum-and-coke. The total order cost 414 now reflects the total cost of the three drinks ($15.50). A tip amount 421 is shown defaulting to 15% with increase and decrease functions to add more/less tip before placing the order. Once the order (and tip, if desired) is ready, the patron 662 selects the “place order” function 417 and the order is transmitted to the server computer 500. The server computer 500 processes the order and forwards the order from the server computer 500 to the ordering terminal 680 located at the establishment 601. Example user interfaces of the ordering terminal 680 are shown in FIGS. 14-16.

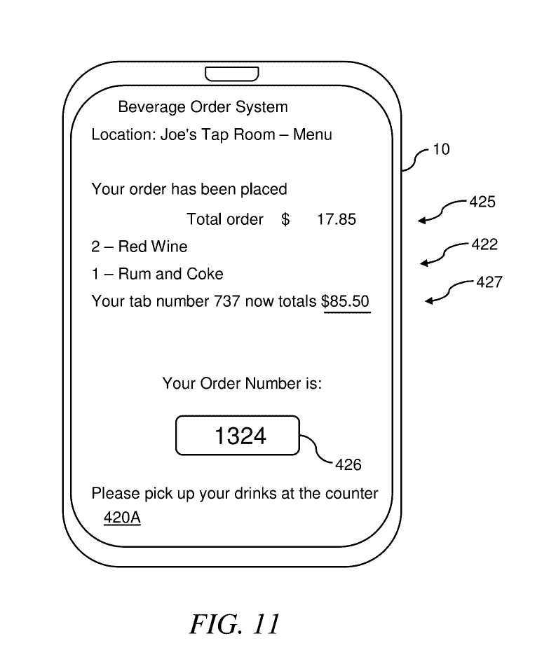

Also, once the patron 662 places the order, a financial record is created, with various payment options. One payment option is to charge immediately to a pre-determined stored form of payment such as a credit card, debit card, pre-paid debit card, payment service, etc. In such, the total order cost 414 is forwarded to the server computer 500 and the server 500, based upon an agreement with the establishment, deducts an amount or percentage from the total order cost 414, then process the remainder of the total order cost 414 through the establishment's point-of-sale system 600. Other payment options are also anticipated, including creating and running a tab 427 (see FIG. 11), payments in cash (or check), and splitting the payments between multiple people/users, as invoked using the “split” feature 423 which provides a user interface to enter multiple payment methods (e.g. from multiple payers) and an amount or percentage payment for each payer.

In some embodiments, the server 500, based upon an agreement with the establishment, deducts a variable amount or percentage from the total order cost 414. For example, as more patrons 662 join the system, the percentage increases. As another example, as the number of patrons 662 in a certain geographic area increases to a certain point, as the number of patrons 662 visiting a certain establishment 601 increases to a certain point, etc., the percentage changes, either up or down.

Besides all the advantages for the patron 662, the establishments 601 benefit from the order placing service through the elimination of two steps: the step of taking the order (e.g., by the bartender 602) and the step of accepting payment (e.g., again, by the bartender 602). The order system speeds up the process of drink ordering and payment, enabling each bartender 602 to prepare more drinks, improving satisfaction of the bartender(s) 602 and increasing tips through such efficiency. The patron 662 is happier not having to maneuver through a crowd of other customers 652 and having an efficient way to purchase items.

In FIG. 8, a custom order user interface 490 is shown providing the ability to request custom items. In the custom order user interface 490, the patron 662 has features for selecting ingredients 491 (in this example, drink ingredients) and then, once all ingredients are selected, the “place order” function 417 is invoked.

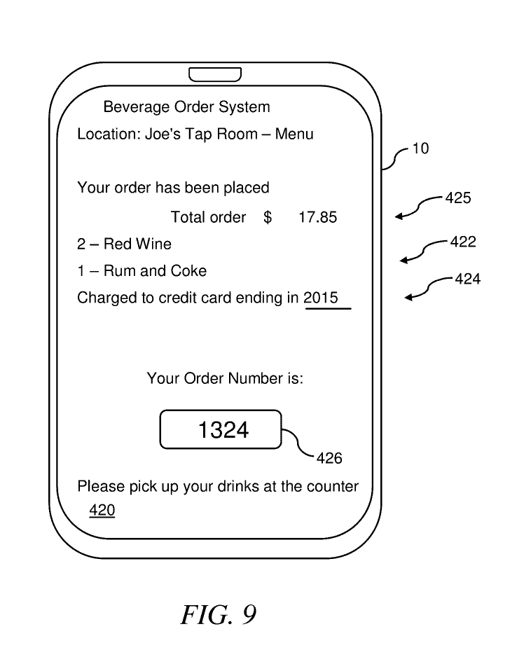

Once the order is placed through any of the anticipated menu/order interfaces 410, a fulfillment user interface 420 as shown in FIG. 9 is displayed. In this fulfillment user interface 420, the order total 425 is displayed (including tip, though it is anticipated that the tip be added in this interface or displayed separately from the order total. A summary of what was ordered 422 is displayed along with the method of payment 424. In some embodiments, an order number 426 is displayed, preferably in large fonts so that the bartender 602 is able to clearly see the order number 426 when the other patron 662 picks up the drinks (or the drinks are delivered to the table 620).

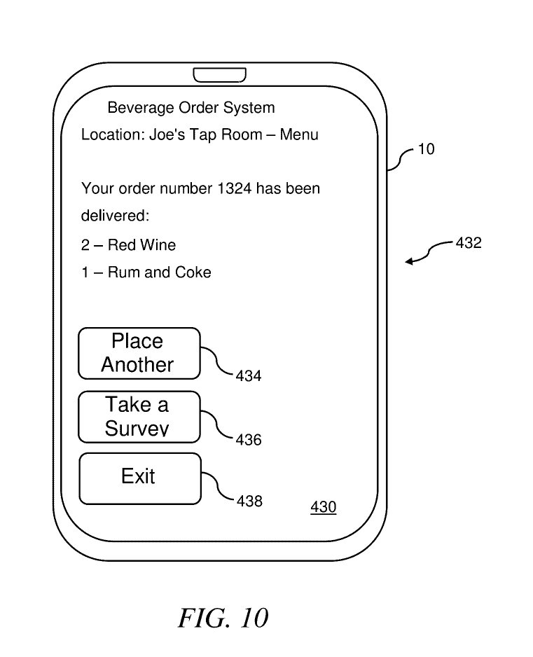

In FIG. 10, a confirmation user interface 430 is displayed showing the products that were ordered 432 (and delivered) with next steps of placing another order 434, taking a survey 436, or exiting the application 438. If placing another order 434 is selected, the application reverts back to the menu/order user interface 410 for ordering additional items. If take a survey 436 is selected, a survey user interface is displayed, providing a way for the patron 662 to rate the establishment on various subjects such as order efficiency, item costs, and overall appearance of the establishment, drink strength and taste, etc., for example on a scale of one star to five stars, etc. The patron 662 is also able to provide feedback to the bartender(s) as to the appearance, mannerism, etc.

In some embodiments, the patron 662 is provided the ability to run a tab 427. When a patron 662 that is running a tab 427 finishes placing an order through the menu/order user interface 410, a tab-fulfillment interface 420A is displayed. In this tab-fulfillment interface 420A, the order total 425 is displayed (including tip, though it is anticipated that the tip be added in this interface or displayed separately from the order total. A summary of what was ordered 422 is displayed along with the tab 427 amount. As in the fulfillment user interface 420, in some embodiments, an order number 426 is displayed, preferably in large fonts so that the bartender 602 is able to clearly see the order number 426 when the other patron 662 picks up the drinks (or the drinks are delivered to the table 620).

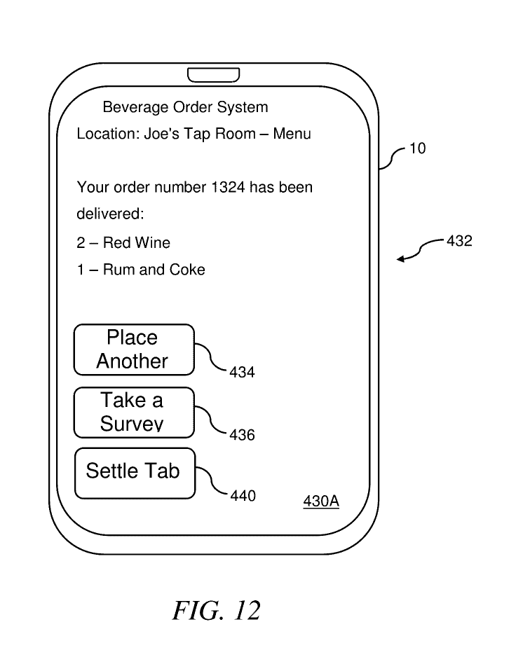

In FIG. 12, a tab-confirmation user interface 430A is displayed showing the products that were ordered 432 (and delivered) with next steps of placing another order 434, taking a survey 436, or “settling tab” 440. If placing another order 434 is selected, the application reverts back to the menu/order user interface 410 for ordering additional items. If take a survey 436 is selected, a survey user interface is displayed, providing a way for the patron 662 to rate the establishment on various subjects such as order efficiency, item costs, and overall appearance of the establishment, drink strength and taste, etc. The patron 662 is also able to provide feedback to the bartender(s) as to the appearance, mannerism, etc.

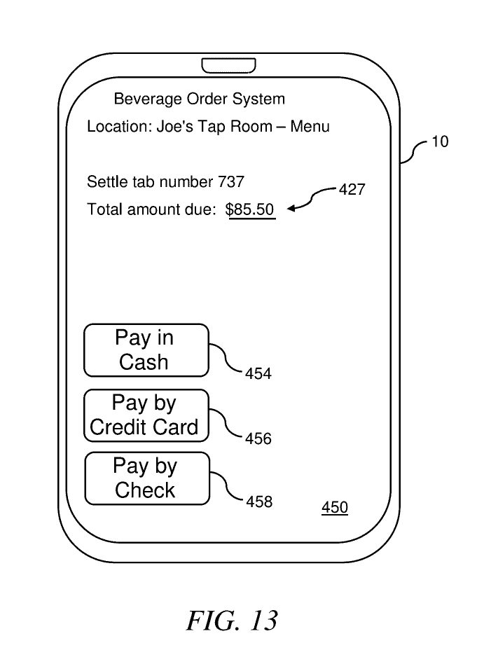

If the “settle tab” function 440 is selected, a tab-payment user interface 450 is displayed, for example the tab-payment user interface 450 shown in FIG. 13. In the, the current tab 452 is displayed with features of pay-in-cash 454, pay by credit card 456, pay-by-check 458, etc. If the patron 662 selects pay-in-cash 454 or pay-by-check 458, a check-out user interface 470 is displayed at the ordering terminal 680 at the establishment 601 so that the bartender 602 can accept the selected form of payment and, optionally, check the identification (e.g. driver's license) of the patron 662. If pay by credit card 456 is selected, a process similar to that above is performed to collect the amount due from the preferred credit card of the patron 662, either from stored credit card/debit card information or from credit card information that is entered into the application during settlement.

Note that, it is anticipated that in some embodiments, a tab 427 is held open, ending when there has been no activity for a predetermined amount of time (e.g., no order placed within the last 45 minutes) or when the application notices the patron 662 (and cell phone 10) has relocated to a location distal from the establishment 601 by a certain distance (e.g., the patron 662 has likely left the establishment).

Referring to FIGS. 14-16, schematic views of bar-located user interfaces of the beverage ordering system are shown. Again, these are exemplary user interface screens as there are many anticipated ways to portray the same or similar information and requests by other user interface paradigms such as lists, text, icons, etc.

Once the “place order” function is selected in the application running on the cell phone 10 of the patron 662, a transaction is sent to the server computer 500 to place the order. The server computer 500 performs a billing activity that, optionally, includes a transaction with the point-of-sale system 600 associated with the establishment 601, to complete billing for the order or the server computer 500, optionally, maintains a tab for the patron 662. The server computer 500 communicates with the ordering terminals 680 at the establishment 601 and presents the user interfaces 460/460A/470 or similar to inform the bartender(s) 602 of the order.

In some embodiments, items from multiple orders are sorted so that the bartender(s) 602 are able to batch produce the items. For example, if one patron 662 orders a margarita and another patron 662 also orders a margarita, the bartender(s) 602 will see both at the same time and can double the batch being made in a blender.

In the example user interface 460 of FIG. 14, the items being ordered 462 are displayed along with two functions 464/466. The first is a “ready” function 464 that the bartender 602 invokes (e.g. by mouse, keyboard, or touchscreen operation) after the items (e.g., drinks) are prepared and ready at the pre-determined pickup location 614 (e.g., a location pre-designated for picking up such orders). After the “ready” function 464 is invoked, the server computer 500 is notified and the server computer 500 sends a transaction to the cell phone 10 to inform the patron 662 that the order is ready at the pre-determined pickup location 614 so that the patron 662 knows to pick up the order at the pre-determined pickup location 614. Alternately, if the bartender 602 is not comfortable making the order, perhaps the bartender 602 lacks one of the ingredients needed to fulfill the order (e.g. is out of rum, etc.) or the bartender 602 believes the patron 662 will not pay for the items ordered, the bartender 602 invokes the “refuse” function 466 and the server computer 500 is notified. Receiving the notification, the server computer 500 sends a transaction to the application running on the cell phone 10 to inform the patron 662 that there is an issue and the patron 662 must see the bartender 602. Again, this is an exemplary user interface and more or less information and/or functions are anticipated such as more complete information regarding the patron 662 (e.g. name), table number, time of order, time/date of last order, order history (e.g. to judge impairment levels), etc.

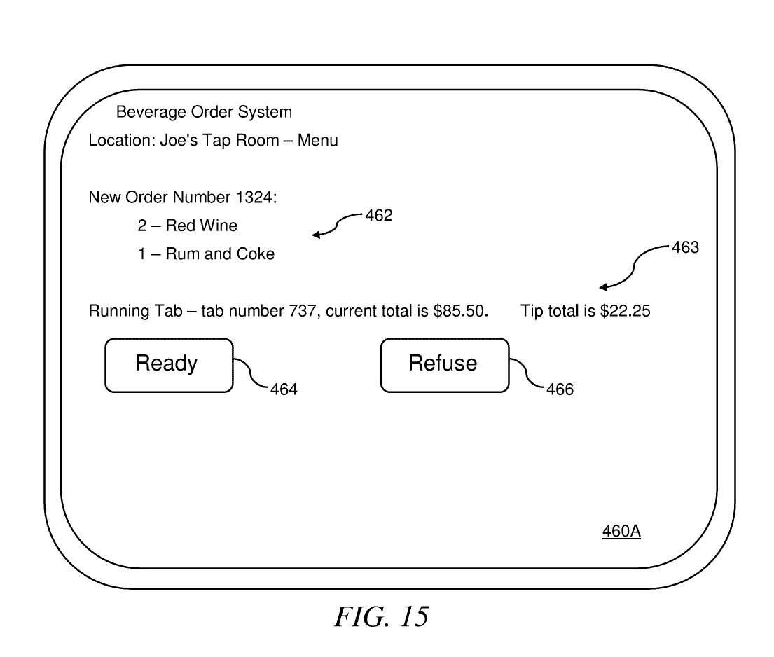

In the example user interface 460A of FIG. 15, the items being ordered 462 are displayed along with a tab summary 463 and two functions 464/466. The first is a “ready” function 464 that the bartender 602 invokes (e.g. by mouse, keyboard, or touchscreen operation) after the items (e.g., drinks) are prepared and ready at the pre-determined pickup location 614. After the “ready” function 464 is invoked, the server computer 500 is notified and the server computer 500 sends a transaction to the cell phone 10 to inform the patron 662 that the order is ready at the pre-determined pickup location 614 so that the patron 662 knows to pick up the order at the pre-determined pickup location 614. Alternately, if the bartender 602 is not comfortable making the order, if the bartender 602 lacks one of the ingredients needed to fulfill the order (e.g. is out of rum, etc.) or if the bartender 602 believes the patron 662 will not pay the tab, the bartender 602 invokes the “refuse” function 466 and the server computer 500 is notified. Receiving the notification, the server computer 500 sends a transaction to the cell phone 10 to inform the patron 662 that there is an issue and the patron 662 must see the bartender 602. As above, this is an exemplary user interface and more or less information and/or functions are anticipated such as more complete information regarding the patron 662 (e.g. name), table number, time of order, time/date of last order, order history (e.g. to judge impairment levels), etc.

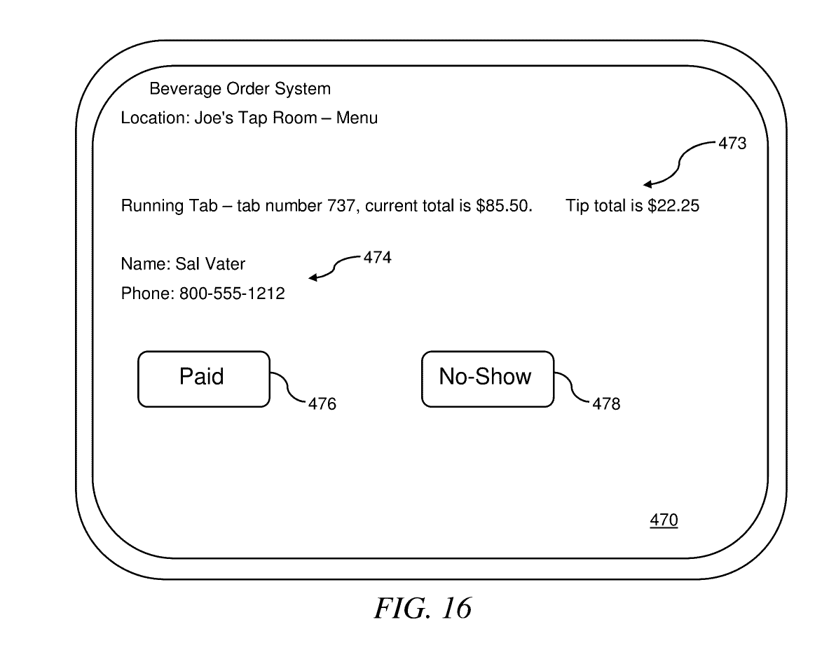

The exemplary check-out user interface 470 shown in FIG. 16 is initiated after the patron 662 invokes the “settle tab” function 440, then selects “pay in cash” 454 or “pay by check” 458. In this, the application running on the cell phone 10 sends a transaction to the server computer 500 to settle the tab. If the tab is to be paid by credit, debit, payment system, etc., the server computer 500 processes the payment either directly or through the point-of-sale system 600 associated with the establishment 601. If the tab is to be paid by cash or credit, the server computer 500 informs to bartender that the patron 662 will be making a payment through the check-out user interface 470. The check-out user interface 470 in this example shows the tab number (e.g., 737), the total tab due, the tip due 473 along with identification information 474 regarding the patron 662. In this example, identification information 474 includes the name and phone number of the patron 662, though more or less information is fully anticipated including, but not limited to, address, photograph, description of the patron 662, time that the patron 662 initiated the settlement, etc.

Once the tab is paid, the bartender 602 indicates such by invoking the “paid” function 476, informing the server computer 500 that the tab has been paid to close the tab internally and generate any billing records needed to initiate payment from the establishment 601 to the ordering system operator, being that the establishment has received the full payment in cash or check.

In the event that the patron 662 never approaches the bartender 602 to make the payment, the bartender 602 invokes a “no-show” function 478 to indicate to the server that the patron 662 likely left without paying and, therefore, a record is maintained of such and billing is updated to indicate such. In this case, it is anticipated that the patron 662 will be contacted to request payment through other means, possibly though information obtained when the patron 662 created an account, or the patron 662 will be prevented from using the beverage ordering system in the future, at least until payment is arranged.

In some embodiments, when the establishment 601 has multiple bartenders 602, the orders displayed on the bar-located user interfaces are pre-assigned to one of the bartenders 602 or, when one of the bartenders 602 starts an order displayed on the bar-located user interface, that bar tender 602 associates the order with that bartender's 602 number (e.g., an identification number). In such, it is also anticipated that the orders be colored to highlight all orders for a particular bartender 602 in one color, etc. In some embodiments, as time passes and there is no indication that the order was fulfilled, the order display displayed on the bar-located user interface become increasingly difficult to ignore through flashing, color changes, audible noises, etc., all of which help draw attention of the bartender(s) 602.

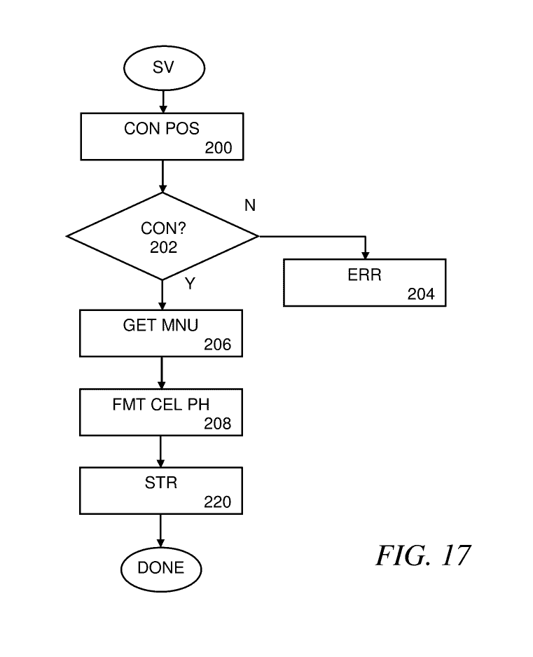

Referring to FIGS. 17-19, exemplary flow charts of the beverage ordering system are shown. The program flows shown in these figures are examples of one possible flow, as many different program flows are anticipated with more, less, and/or different steps achieving the same or similar functions.

In FIG. 17, the exemplary software flow depicts the activities performed by the server computer 500 when a new establishment 601 is added or an existing establishment 601 changes one or more items on their menu. In this, the server computer 500 connects 200 to the point-of-sale system 600 of the establishment 601. If the connection fails 202, an error exists 204 and is handled (e.g. a message on an operator console, logging, etc.).

It is anticipated that new establishments 601 are added after the establishment 601 agrees to the terms of the item order system management such as the portion of each transaction that is paid to the item order system (e.g. percentage of each order total), and any other terms applicable. The establishment 601 then installs the point-of-sale interface software 599 on the point-of-sale system 600. This point-of-sale interface software 599 is needed for the server computer 500 to communicate with the point-of-sale system 600 and is typically a plug-in designed to operate on the particular the point-of-sale system 600 at that establishment 601. This point-of-sale interface software 599 provides access to the item menus (e.g., drink menus) stored on the point-of-sale system 600 and provides payment transaction features for credit card, debit card, etc., transactions, as well as any other needed transactions.

After the connection between the server computer 500 and the point-of-sale system 600 is established, the server computer 500 obtains the current menu 206 from the point-of-sale system 600 (again with proper error checking, etc.). The server computer 500 then formats 208 the menu for display on a typical cell phone 10. In some embodiments, multiple menu formats are created, one for each supported cell phone 10 type. After the server computer 500 formats 208, the server computer 500 stores 220 the formatted menu(s), for example, in the data storage 502.

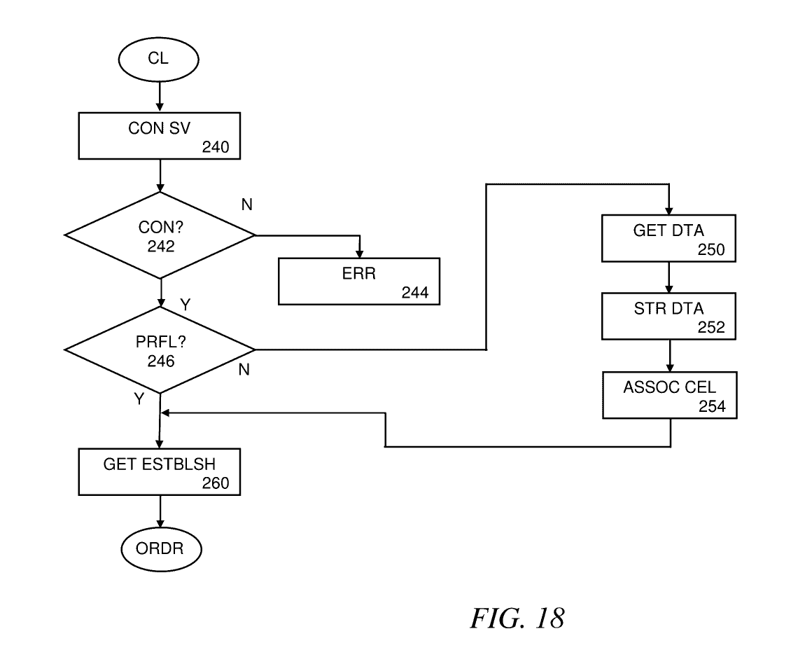

In FIG. 18, the exemplary software flow depicts the activities performed by the cell phone 10 (application) after connecting to the server computer 500. The first step is for the cell phone 10 to connect 240 to the server computer 500. If the connection fails 242, an error 244 is processed (e.g., display a message, log issue, etc.). After the cell phone 10 connects 240, it is determined if this cell phone 10 has a profile 246, for example, by determining if required fields of the profile are populated, etc. If there is no profile 246, a user interface is used to get profile data 250, store the profile data 252 (either in the persistent memory 74 of the cell phone 10, in the data storage 502 of the server computer 500 or both). This is for example a request for the name of the patron 662, payment preferences and card numbers, etc. In some embodiments, a birthdate of the patron 662 is captured for verification of alcoholic beverages, etc. Since it is easy to enter a fictitious birthdate, in such embodiments, it is anticipated that upon using the system for the first time, a note is presented to the bartender 602 informing the bartender 602 that a valid proof of age is required. In some embodiments, some or all of the data for the profile is extracted from values available from the persistent memory 74 or SIM card 88 of the cell phone 10, for example, the phone number of the cell phone 10. Any user interface is anticipated. It is also anticipated that a pin is part of the profile and data in the profile is encrypted using the pin, limiting unwanted access to data within the profile such as payment credentials, etc. Further, it is anticipated that some or all communications between the application running on the cell phone 10 and the server computer 500 are encrypted for added protection of any sensitive data that is communicate, again, such as payment credentials, etc.

Once the profile is either entered or is already present, the application running on the cell phone 10 presents a user interface, for example, the map user interface 400, to determine/select 260 which of the establishments 601 are of interest to the patron 662. In the map user interface 400 of FIG. 5, a map with flags representing pre-negotiated establishments 601 is presented and the patron 662 selects an establishment 601. Again, any user interface is anticipated for selecting an establishment 601, for example, a list of establishments sorted by name or location, etc.

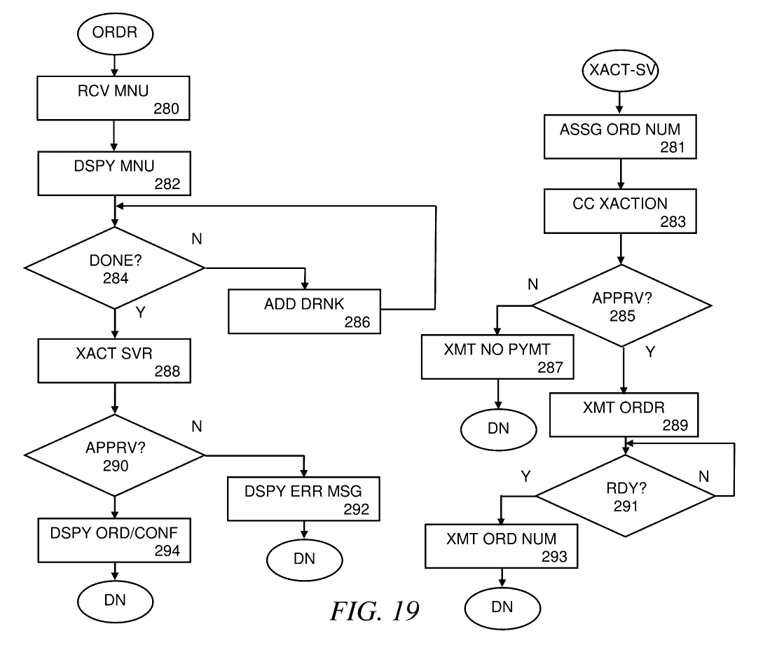

Once an establishment 601 is selected 260, an exemplary flow of the order processing is show in FIG. 19, both that which is performed by the application running on the cell phone 10 (ORDR) and that which is performed by the server computer 500 (e.g., XACT-SV).

After the establishment 601 is selected 260, the menu of that establishment 602 is retrieved 280 from the server computer 500 and the menu (along with ordering features) is displayed 282 on the display 86 of the cell phone 10, for example, using the menu/order user interface 410. In this exemplary flow, the process of adding drinks is shown, in that, until the done (e.g. “place order”) function is invoked 284, inputs are processed 286 to add additional drinks (or remove previously ordered drinks, etc.) as, for example, as was described in FIGS. 6 and 7 as one possible menu/order user interface 410.

Once done (e.g. “place order” function is invoked) 284, a transaction is sent 288 to the server to place the order. In XACT-SV, the server assigns 281 an order number 426 (see FIG. 9). The order number is, for example, any sequential number, random number, pseudo-random number, etc. This example flow is for a credit card transaction for payment of the order total (no tab). In this, the server computer 500 initiates a credit card transaction 283 to the point-of-sale system 600 associated with the establishment 601. If the transaction is not approved 285, a failure transaction is sent 287 to the application running on the cell phone 10 and a message is displayed on the display 86 of the cell phone 10 indicating to the patron 662 that the order was not placed because the credit card transaction failed. If the transaction is approved 285, the order (e.g., list of drinks ordered) is transmitted 289 to the ordering terminal 680 for fulfillment by the bartender 602. The server computer 500 then waits for an indication that the order is ready 291 from the ordering terminal 680. Once the order is ready 291, the order number 426 is transmitted 293 back to the application running on the cell phone 10. For simplicity, loop timeouts and error conditions are not shown as such are known in the industry.

At the application running on the cell phone 10, after receiving the result of the transaction is sent 288, if the transaction is not approved 290, an error message is preferably displayed 292 on the display 86 of the cell phone 10. If the transaction is approved, the transaction includes the order number 426, which is then displayed as part of a message on the display 86 of the cell phone 10, indicating to the patron 662 that the order is ready for pickup, for example, using the fulfillment user interface 420 shown in FIG. 9.

In some embodiments, the establishment 601 has an option for “all you can eat” or “all you can drink.” In this, a similar user interfaces to those described is presented, except an option for selecting the “all you can” feature is present, for example, on the menu/order user interface 410. In this, once the “all you can” feature is selected (and the payment is processed), the menu/order user interface 410 includes mechanisms for ordering (e.g., ordering drinks), but there is no price next to the items (e.g., drinks) that are included in the “all you can” option. In this, it is anticipated that some items are not included in the “all you can” option and further payment is necessary for those items not included. It is also anticipated that, in some embodiments, a totally different menu is presented, limiting the order choices once the “all you can” option is selected. For example, in this embodiment, the different menu for drinks only includes well drinks, domestic beer, and house wines.

In some embodiments, data is recorded regarding the performance of the bartender(s), in particular, the time between when the patron 662 places the order and when the “ready” function is invoked, providing feedback data to employees of the establishment 601. In some embodiments, data is recorded for individual establishments 601 and/or for geographically associated sets of establishments 601 regarding historical ordering of items so as to enable future predictions of needs. For example, data is presented to the establishments 601 regarding consumption on certain holidays such as S. Patrick's Day, for example in absolute numbers (35,000 cases of beer were consumed on S. Patrick's Day last year) or relative numbers (each establishment 601 in the area sold 4.7 times the average quantity of beer on S. Patrick's Day last year), etc.

Further, in some embodiments, links are provided between cell phones 10 of patrons 662 and/or links to social networking enabling social interactions, comments regarding the establishment 601, etc.

Again, for clarity reasons, the above examples, flow charts, and user interfaces use as an example of drink orders to describe the ordering system. It is fully anticipated that the order system be used for any items, including drinks, food, coffee, ice cream, clothing, novelty items, glass ware, packaged food, bulk coffee, etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for ordering items from a portable device, the system comprising:
a server;
a portable device communicatively connected to the server through a network;
a point-of-sale system associated with an establishment, the point-of-sale system communicatively connected to the server through the network;
an ordering terminal associated with the establishment, the ordering terminal communicatively connected to the server through the network;
a menu retrieved from the point-of-sale system by the server;
an application stored in non-transitory memory interfaced to the portable device, the application presenting a user interface for selecting the establishment, upon the application receiving a selection of the establishment, the application presenting a menu interface including items from the menu and including ordering options, the application accepting an order and sending the order to the server;
upon receipt of the order from the portable device by the server, the server presents details of the order at the ordering terminal associated with the establishment; and
after fulfillment of the order, a completion transaction is conveyed from the ordering terminal to the server and upon receipt of the completion transaction, the server sends another completion transaction to the portable device indicating that the order is ready.

2. The system of claim 1, wherein the order is received at a pre-determined location within the establishment.

3. The system of claim 1, wherein the order is delivered to a table associated with the portable device.

4. The system of claim 1, wherein the portable device is a cell phone.

5. The system of claim 1, wherein the details of the order include an order number, the order number also include in the completion transaction and the order number is displayed on a display of the portable device for confirmation of the order.

6. The system of claim 1, wherein the establishment is a bar.

7. The system of claim 1, whereas the server maintains a tab.

8. The system of claim 7, whereas the tab is closed after a time of inactivity and the tab is charged to a payment method associated with the portable device.

9. The system of claim 7, whereas the tab is closed after the portable device moves away from the establishment by a predetermined distance and the tab is charged to a payment method associated with the portable device.

10. The system of claim 1, further comprising the server initiating payment for the order by sending a transaction to the point-of-sale system including a total amount due and a payment method associated with the portable device.

11. The system of claim 1, whereas after the order is received, a survey is presented on the display of the portable device, the survey requesting feedback for the order.

12. A method of ordering items at an establishment, the method comprising:
running an application on a portable device, the application presenting an establishment selection user interface;
the application receiving a selection of the establishment;
the application retrieving a menu associated with the establishment from a server and the application presenting the menu on a display of the portable device;
the application receiving one or more item selections;
the application sending the one or more item selections to the server;
the server displaying the item selections at a terminal associated with the establishment;
after fulfilling the items, sending a completion transaction from the terminal associated with the establishment to the server; and
the server sending a transaction to the application indicating the items are fulfilled, the application displaying a message indicating that the item selections are ready on the display of the portable device.

13. The method of claim 12, wherein the portable device is a cell phone.

14. The method of claim 12, further comprising a step of delivering the item selections to a table associated with the portable device.

15. The method of claim 12, further comprising a step of billing a preferred method of payment associated with the portable device.

16. An apparatus for ordering items, the apparatus comprising:
a portable device having a processor, a display, a memory, an input device, and a communications interface;
an application stored in the memory, the application running on the processor, the application presenting a user interface on the display representing a selection of establishments and the application receiving a selection of one establishment from the input device;
the application then retrieving a menu from a server and displaying the menu on the display, the menu is of items associated with the one establishment; the application then receiving selections of one or more items of the menu from the input device;
the application sending a list of the one or more items to the server;
the server presenting the list of the one or more items to a terminal associated with the one establishment for a person at the one establishment to prepare/deliver; and
the one or more items are delivered.

17. The apparatus for ordering items of claim 16, wherein the one or more items are delivered to a location selected from the group consisting of a pre-determined location within the one establishment and a table associated with the portable device.

18. The apparatus for ordering items of claim 16, wherein the portable device is a cell phone.

19. The apparatus for ordering items of claim 16, wherein the application tracks a cost of each of the one or more items and a total cost and the server processes a payment transaction for the total cost.

20. The apparatus for ordering items of claim 19, wherein the server processes the payment transaction for the total cost through one or more transactions with a point-of-sale system associated with the one establishment.
